(19) United States
(12) Patent Application Publication
(10) Pub. No.: US 2003/0037009 A1
(43) Pub. Date: Feb. 20, 2003

(54) Monitoring and managing delivery of shipped items

(76) Inventors: Christopher M. Tobin, McLean, VA (US); Harold Aaron Ludtke, San Jose (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/932,693

(22) Filed: Aug. 16, 2001

(51) Int. Cl. G06F 17/60

(52) U.S. Cl. 705/65

(57) ABSTRACT

A package to be shipped to a user is diverted to a new delivery location upon receipt of a redirection request for the package from the user. The redirection request specifies a package identifier for the package and the new delivery location, which are transmitted to the entity responsible for the package, such as a vendor or a distribution network. The redirection request may be received in response to a delivery notification that is transmitted to the user upon request or on a periodic basis. In another aspect, when the new delivery location is a secure delivery location, an authentication code to release the package from the secure delivery location is generated and associated with the package. The authentication code is transmitted to the user and also to the secure delivery location.

### BACKGROUND OF THE INVENTION

1. Field of the Invention

The present invention relates to electronic monitoring and managing of shipped items. More particularly, the invention relates to electronically diverting a shipped item to a different location.

2. Art Background

Today the shipment of packages over distances large and small is a commonplace occurrence. Electronic tracking systems give consumers the ability to track an item, such as a package, along the course of its movement from shipping source to destination. The systems available from commercial shippers, such as United Parcel Service (UPS) and Federal Express, and some private delivery services, offer automated and sometimes, personalized, tracking services. These services provide useful information pertaining to shipments in transit.

Consumers using such services are often confronted (for various reasons) with being unable to receive, at an appropriate location, a shipment of goods that they have ordered. This happens most typically, when the consumer receives a notice that a shipment is due for delivery one place (e.g. home), but is unable to receive the shipment because they are at another place (e.g. office, vacation). Existing services do not have systems in place that adequately address such problems, and do not provide the customer with a means of redirecting the packages to a more appropriate delivery location once such a situation arises.

### SUMMARY OF THE INVENTION

A package to be shipped to a user is diverted to a new delivery location upon receipt of a redirection request for the package from the user. The redirection request specifies a package identifier for the package and the new delivery location, which are transmitted to the entity responsible for the package, such as a vendor or a delivery network. The redirection request may be received in response to a delivery notification that is transmitted to the user upon request or on a periodic basis. In another aspect, when the new delivery location is a secure delivery location, an authentication code to release the package from the secure delivery location is generated and associated with the package. The authentication code is transmitted to the user and also to the secure delivery location.

### BRIEF DESCRIPTION OF THE DRAWINGS

The objects, features and advantages of the present invention will be apparent from the following detailed description in which:

FIG. 1 is a block diagram of one embodiment of a distribution transaction architecture that allows redirecting of shipped packages.

FIG. 2 is a block diagram of one embodiment of a distribution transaction clearing house in the distribution transaction architecture shown in FIG. 1.

FIG. 3 is a flow diagram for one embodiment of a method that redirects a shipped package.

FIG. 4 is a simplified block diagram of one embodiment of a secure transaction system.

FIG. 5 is a simplified block diagram of one embodiment of a privacy card for a personal transaction device for use with the secure transaction system of FIG. 4.

FIG. 6 is a simplified block diagram of one embodiment of a digital wallet for a personal transaction device for use with the secure transaction system of FIG. 4.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well known electrical structures or circuits are shown in block diagram form in order not to obscure the present invention unnecessarily.

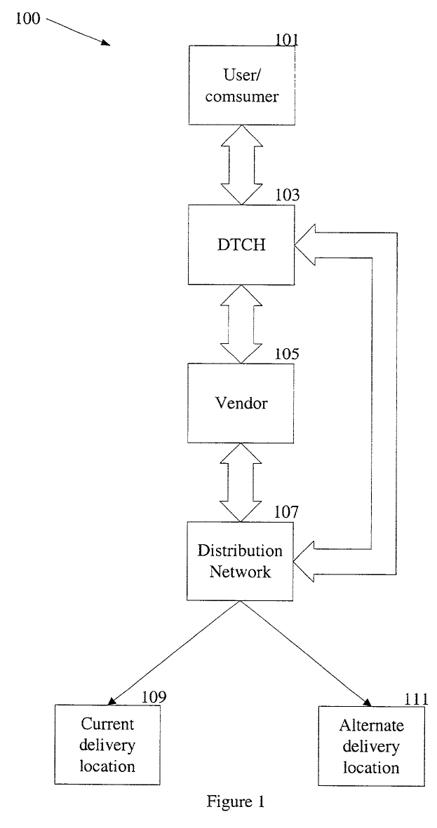

As illustrated in FIG. 1, a distribution system 100 for delivery monitoring and managing of packages is controlled by a distribution transaction clearing house (DTCH) 103. The DTCH 103 allows a user 101 that has ordered items from a vendor 105 to:

periodically review the status of a package to be received through a private or commercial distribution network 107;

receive notification that a particular package is due for arrival, e.g., via an audible or visible alarm; and

remotely alter a current specified delivery location 109 for the package,

and thus redirect the shipping destination of the package to an alternate location 111 that is more appropriate than the current location 109.

A shipment may be redirected to assist customers who are confronted with being unable to receive a shipment of ordered items due for delivery to one address (e.g. home), because they are currently located at another (e.g. office, vacation). This feature may help to eliminate loss of packages and shipments due to their delivery to inappropriate addresses. The distribution system 100 may also give consumers more control over the package delivery process, allowing them to adapt the process to changed circumstances.

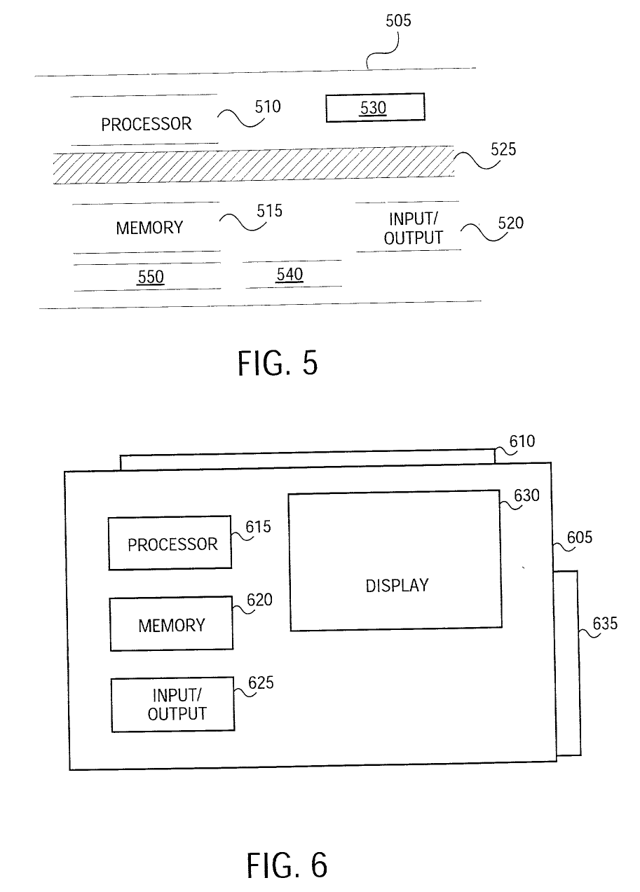

Communication between the user 101 and the DTCH 103 is through a electronic, magnetic or optical user device, such as a personal computer, handheld device, wireless telephone or pager, or the like, that is configured to receive communications from DTCH 103 and perform functions examples of which are enumerated herein. In one embodiment, the user device is a personal transaction device as described further below in conjunction with FIGS. 5 and 6.

In one embodiment, when the DTCH 103 sends a delivery notification to the user 101 specifying when the package is to be delivered, the user device displays the status and prompts the user 101 to initiate a package delivery transaction for transmission to DTCH 103. Assuming that the user 101 wishes to change the delivery location of the package, the new delivery location is input by the user and is incorporated into a delivery transaction that requests redirection of the package. The DTCH 103 transfers a package identifier and the new delivery location to the vendor 105, which subsequently re-addresses the package to the new location. If the package is already in the distribution network 107, the DTCH 103 transfers the package identifier and the new location information directly to the distribution network 107.

In one embodiment, the package identifier is coded on the shipping label instead of the delivery location. The vendor and distribution network maintain an association between the identifier and the delivery location to avoid having to re-label the package when the delivery location changes. The package identifier may barcode data, or other machine readable code schemes presently readable by a barcode reader or similar device. In an alternate embodiment, the package identifier is encoded into an electronic label that can be read from and written to using wireless transmission technology. The delivery location is returned in response to reading the package identifier.

The new location may be a residential or business address, or a “delivery pick-up” kiosk that can securely receive the shipment, and securely allow the user to pick-up the shipment at a later date. In one embodiment, when the new location is a kiosk, the DTCH 103 redirects the shipment to the kiosk and generates an authentication code that is subsequently associated with the package by the vendor/distribution network. The code is also provided to the user 101 in response to the delivery transaction that requested the redirection. When the user 101 goes to the kiosk, the user 101 inputs the code. Assuming the kiosk authenticates the code, it provides the corresponding package to the user 101 by, for example, unlocking an appropriate door on the kiosk. In an alternate embodiment, the DTCH 103 sends the authentication code and the package identifier directly to the kiosk, and the kiosk associates the appropriate authentication code with each package it receives based on the package identifier.

The kiosk may be configured a variety of ways. In one embodiment, the kiosk stores a plurality of packages to be delivered to a number of users. In an alternate embodiment, the kiosk is a secured transportable storage box that is dropped off at the delivery location. The transportable kiosk containing the package can be redirected to another address in the same fashion as redirecting a package.

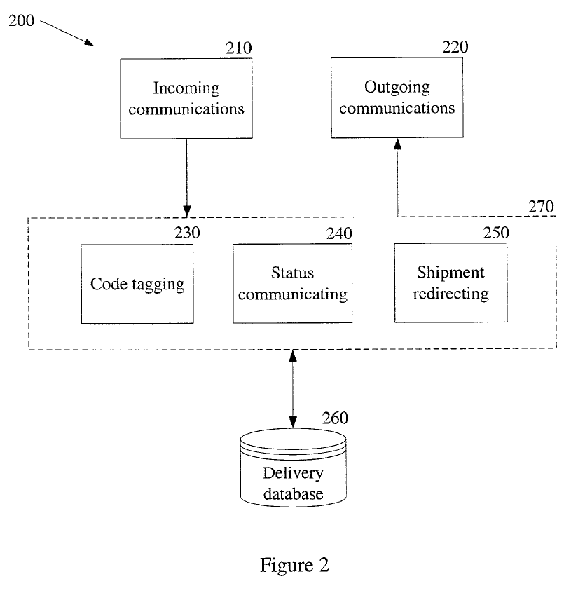

FIG. 2 illustrates one embodiment of a distribution transaction clearing house 200 suitable for use as DTCH 103. DTCH 200 includes an incoming communications component 210, an outgoing communications component 220, a code tagging component 230, a status communicating component 240, a shipment redirecting component 250, (collectively referred to as functions 270), and a delivery database 260. The DTCH components may be implemented in a variety of ways including hardware, software, and a combination of both hardware and software. In one embodiment, at least some of the functions are implemented as instructions stored on a computer readable medium which, when executed by a processing system perform the functions described herein.

Referring to FIG. 2 and to the relevant structures of FIG. 1, incoming communications component 210 manages communication to the functions 270 of the DTCH 200 from the users, vendors and distribution networks. Outgoing communications component 230 manages communications from the functions 270 of the DTCH 200 to the users, vendors and distribution networks. Thus, the DTCH 200 may monitor incoming transmissions received from one user for delivery transaction information while also transmitting outgoing communications which deliver periodic status updates to another user. Furthermore, the DTCH 200 may communicate with the users, vendors and distribution networks concurrently.

The status communicating component 240 provides the delivery status updates to the user 105 periodically or upon request. If a delivery transaction is received from a user that requests the redirection of a package, the shipment redirecting component 240 transfers the delivery transaction, or the information in the delivery transaction, to the appropriate vendor or distribution network. If the new delivery location is a kiosk, the code tagging component 203 instructs the vendor or distribution network that a package should be associated with an authentication code and also provides the code to the user. In an alternate embodiment, the package identifier and authentication code are transmitted directly to the kiosk by the code tagging component 203.

The delivery database 260 provides delivery information necessary to support the operation of DTCH 200. The information in the database 260 includes, among other data, the package identifier, vendor, distribution network, delivery schedule, delivery location, tracking number, etc. The information particular to the vendor 105 and distribution network is obtained from the vendors 105 and distribution networks and stored in the database 260 at periodic intervals. It will be appreciated that some vendors or distribution networks may not permit their information to be stored in a third-party database, such as delivery database 260, and that such information is acquired by the DTCH 200 directly from the appropriate vendor/distribution network when needed.

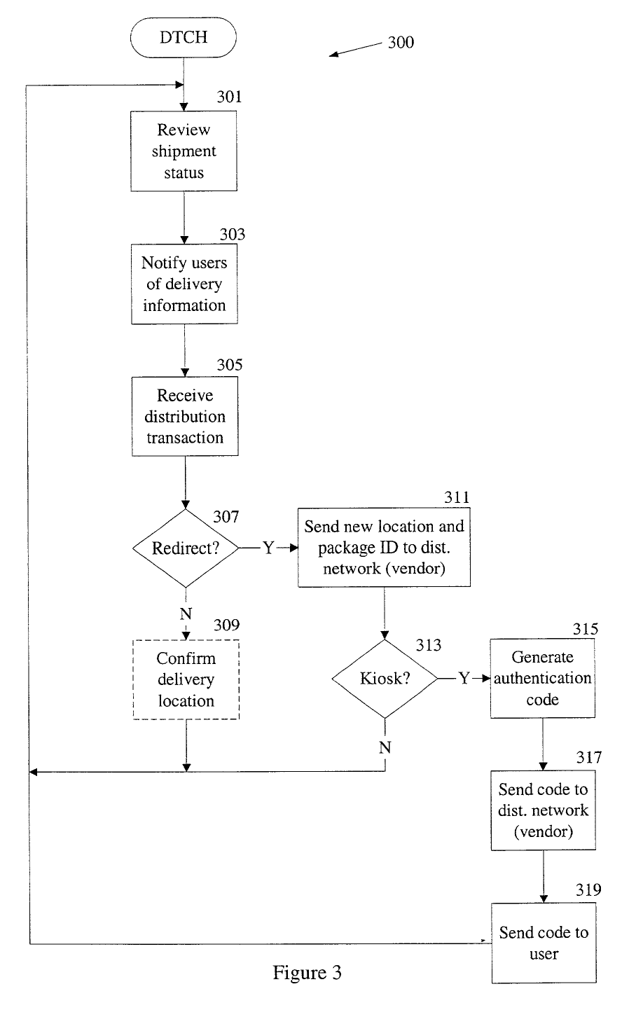

FIG. 3 is a flow diagram of one embodiment of a DTCH method 300 that is executed by a computer to monitor and manage package delivery. The method 300 periodically reviews delivery status information in the DTCH delivery database (block 301) and sends appropriate delivery notifications to users that specifies when their shipments are due to arrive (block 303). The processing at block 303 also may be used to respond to package status requests from a user that are received in between the normal database review periods.

Assuming the user submits a delivery transaction to the DTCH in response to a delivery notification (block 305), the method 300 determines if the transaction is a redirection request (block 307). If not, the delivery transaction is confirming the current delivery location and the confirmation is sent to the appropriate distribution network, as shown in phantom at block 309.

If the transaction is a redirection request, the newly specified location and the identifier for the package is transmitted to the appropriate distribution network (block 311). If the newly specified location is a secure kiosk (block 313), the method 300 generates an authentication code for the package (block 315) and transmits the code to the distribution network (block 317) and the user (block 319). In an alternate embodiment, the authentication code is transmitted directly to the kiosk at block 317.

Assuming that the label on the package is coded with the package identifier, the distribution network associates the new delivery location with the package identifier in its database and utilizes its existing infrastructure as described above to deliver the package to the new location. If the label specified a location instead of the package identifier, the distribution network would re-label the package with the new location.

In an embodiment in which the distribution network receives an authentication code for the package from the DTCH, it associates the authentication code with the package identifier in its database and then securely transmits the package identification and authentication code to the kiosk. In an alternate embodiment, the authentication code can be manually delivered to the kiosk with the package by the distribution network.

Under some circumstances, a user may not wait to receive a notification of delivery before changing the delivery location, such as, for example, when the user will be at a different location for an extended period time during which the package is expected to arrive. The user would contact the DTCH 103 and supply the package identifier and the new delivery location in a package delivery transaction as described above. The DTCH method 300 would receive the package identifier and the delivery location from the user at block 305. Because the vendor may not have released the package to the distribution network at this point, the processing represented at block 307 determines whether to send the redirection information to the vendor or the distribution network, and proceeds accordingly at blocks 311 until 319. If the vendor still has control over the package, the vendor updates its database with the new delivery location and forwards the necessary information to the distribution network when the package is scheduled for delivery.

It will be appreciated that that more or fewer processes may be incorporated into the methods illustrated in FIG. 3 without departing from the scope of the invention and that no particular order is implied by the arrangement of blocks shown and described herein. It further will be appreciated that the method described in conjunction with FIG. 3 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Additionally, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

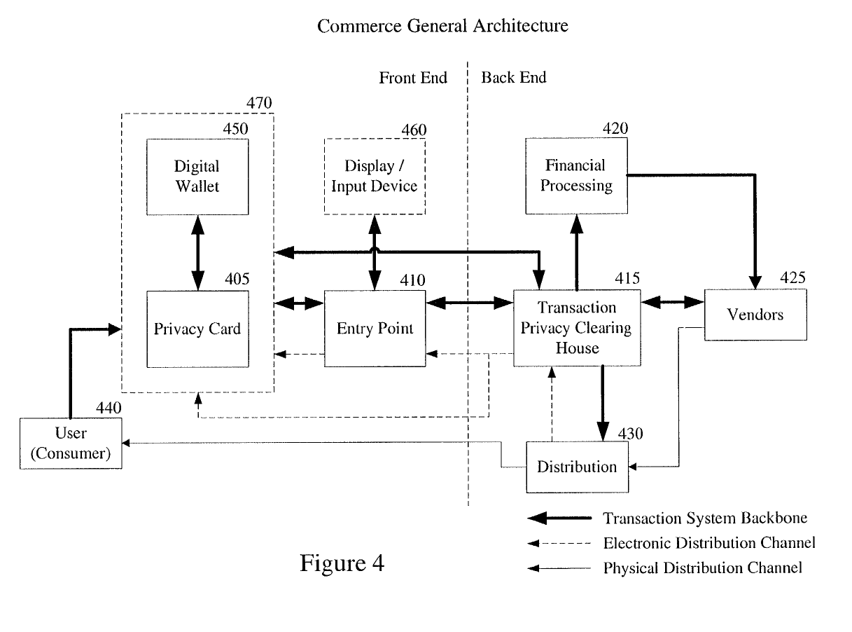

FIG. 4 illustrates one embodiment of a secure transaction system that incorporates the functions of a distribution transaction clearing house as part of one of its components, such as a transaction privacy clearing house (TPCH) 415 or a distribution function 430, or as a separate component that operates in conjunction with the system components.

The TPCH 415 interfaces a user (consumer) 440 and a vendor 425. In the particular embodiment shown in FIG. 4, a personal transaction device (PTD) 470, e.g., a privacy card 405, or a privacy card 405 coupled to a digital wallet 450, is used to maintain the privacy of the user while enabling the user to perform transactions. In an alternate embodiment, the PTD 470 may be any suitable device that allows unrestricted access to TPCH 415. The personal transaction device information is provided LO the TPCH 415 that then indicates to the vendor 425 and the user 440 approval of the transaction to be performed.

In order to maintain confidentiality of the identity of the user 440, the transaction device information does not provide user identification information. Thus, the vendor 425 or other entities do not have user information but rather transaction device information. The TPCH 415 maintains a secure database of transaction device information and user information. In one embodiment, the TPCH 415 interfaces to at least one financial processing system 420 to perform associated financial transactions, such as confirming sufficient funds to perform the transaction, and transfers to the vendor 425 the fees required to complete the transaction. In addition, the TPCH 415 may also provide information through a distribution function 430 that, in one embodiment, can provide a purchased product to the user 440, again without the vendor 425 knowing the identification of the user 440. In an alternate embodiment, the financial processing system 420 need not be a separate entity but may be incorporated with other functionality. For example, in one embodiment, the financial processing system 420 may be combined with the TPCH 415 functionality.

In one embodiment, the financial processing system (FP) 420 performs tasks of transferring funds between the user's account and the vendor's account for each transaction. In one embodiment, the presence of the TPCH 415 means that no details of the transactions, other than the amount of the transactions and other basic information, are known to the FP 420. The TPCH 415 issues transaction authorizations to the FP 420 function on an anonymous basis on behalf of the user over a highly secure channel. The FP 420 does not need to have many electronic channels receiving requests for fund transfer, as in a traditional financial processing system. In one embodiment, a highly secure channel is set up between the TPCH 415 and the FP 420; thus, the FP 420 is less vulnerable to spoofing.

In one embodiment, the FP 420 is contacted by the TPCH 415 requesting a generic credit approval of a particular account. Thus the FP 420 receives a minimal amount of information. In one embodiment, the transaction information, including the identification of goods being purchased with the credit need not be passed to the FP 420. The TPCH 415 can request the credit using a dummy charge ID that can be listed in the monthly credit statement sent to the user, so that the user can reconcile his credit statement. Further, the personal transaction device 405 can include functionality to cause the credit statement to convert the dummy charge ID back to the transactional information so that the credit statement appears to be a conventional statement that lists the goods that were purchased and the associated amount charged.

A display input device 460 (shown in phantom) may be included to enable the user, cr in some embodiments the vendor 425, to display status and provide input regarding the PTD 405 and the status of the transaction to be performed.

In yet another embodiment, an entry point 410 interfaces with the personal transaction device 470 and also communicates with the TPCH 415. The entry point 410 may be an existing (referred to herein as a legacy POS terminal) or a newly configured point of sale (POS) terminal located in a retail environment. The user 440 uses the PTD 470 to interface to the POS terminal in a manner similar to how credit cards and debit cards interface with POS terminals. The entry point 410 may also be a public kiosk, a personal computer, or the like.

The system described herein also provides a distribution functionality 430 whereby products purchased via the system are distributed. In one embodiment, the distribution function 430 is integrated with the TPCH 415 functionality. In an alternate embodiment, the distribution function 430 may be handled by a third party. Utilizing either approach, the system ensures user privacy and data security. The distribution function 430 interacts with the user through PTD 430 to notify the user of product delivery, ship the product to the appropriate location, or to change the shipping address of the product at any time during the distribution cycle. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a the secure kiosk previously described.

As described above, a user connects to and performs transactions with the secure transaction system of FIG. 4 through a personal transaction device (PTD) 470 that has a unique identifier (ID) and includes either the privacy card 405 and/or the digital wallet 350.

One embodiment of a privacy card 505 is illustrated in FIG. 5. In one embodiment, the card 505 is configured to be the size of a credit card. The privacy card includes a processor 510, memory 515 and input/output logic 520. The processor 510 is configured to execute instructions to perform the functionality herein. The instructions may be stored in the memory 515. The memory is also configured to store data, such as transaction data and the like. In one embodiment, the memory 515 stores the transaction ID used to perform transactions in accordance with the teachings of the present invention. Alternately, the processor may be replaced with specially configured logic to perform the functions described here.

The input/output logic 520 is configured to enable the privacy card 505 to send and receive information. In one embodiment, the input/output logic 520 is configured to communicate through a wired or contact connection. In another embodiment, the logic 520 is configured to communicate through a wireless or contactless connection. A variety of communication technologies may be used.

In one embodiment, a display 525 is used to generate bar codes scanable by coupled devices and used to perform processes as described herein. The privacy card 505 may also include a magnetic stripe generator 540 to simulate a magnetic stripe readable by devices such as legacy POS terminals.

In one embodiment, biometric information, such as fingerprint recognition, is used as a security mechanism that limits access to the card 505 to authorized users. A fingerprint touch pad and associated logic 530 is therefore included in one embodiment to perform these functions. Alternately, security may be achieved using a smart card chip interface 550, which uses known smart card technology to perform the function.

Memory 515 can have a transaction history storage area. The transaction history a storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 515 can also have user identity/account information block. The user identity/account information block stores data about the user and accounts that are accessed by the card. The type of data stored includes the meta account information used to identify the account to be used.

One embodiment of a digital wallet 605 is illustrated in FIG. 6. The digital wallet 605 includes a coupling input 610 for the privacy card 505, processor 615, memory 620, input/output logic 625, display 630 and peripheral port 635. The processor 615 is configured to execute instructions, such as those stored in memory 620, to perform the functionality described herein. Memory 620 may also store data including financial information, eCoupons, shopping lists and the like. The digital wallet may be configured to have additional storage. In one embodiment, the additional storage is in a form of a card that couples to the device through peripheral port 610.

In one embodiment, the privacy card 505 couples to the digital wallet 605 through port 610; however, the privacy card 505 may also couple to the digital wallet 605 through another form of connection including a wireless connection.

Input/output logic 625 provides the mechanism for the digital wallet 605 to communicate information. In one embodiment, the input/output logic 625 provides data to a point-of-sale terminal or to the privacy card 505 in a pre-specified format. The data may be output through a wired or wireless connection.

The digital wallet 605 may also include a display 630 for display of status information to the user. The display 630 may also provide requests for input and may be a touch sensitive display, enabling the user to provide the input through the display.

The physical manifestation of many of the technologies in the digital wallet 605 will likely be different from those in the privacy card 505, mainly because of the availability of physical real estate in which to package technology. Examples of different physical representations would include the display, fingerprint recognition unit, etc.

The components of a secure transaction system illustrated in FIGS. 4, 5, and 6 are further described in PCT published patent application number US00/35619, which is assigned to the same assignee as the present application and which is hereby incorporated by reference.

The invention has been described in conjunction with the preferred embodiment. It is evident that numerous alternatives, modifications, variations and uses will be apparent to those skilled in the art in light of the foregoing description.

What is claimed is:

1. A computerized method to monitor and manage delivery of a package to a user comprising:
receiving a redirection request for the package from the user after completion of an order for items to be included in the package, the redirection request specifying a package identifier for the package and a new delivery location; and
transmitting the package identifier and the new delivery location to an entity responsible for the package.

2. The computerized method of claim 1, further comprising:
sending a delivery notification for the package to the user.

3. The computerized method of claim 1, further comprising:
receiving a status request specifying the package identifier from the user; and
transmitting delivery information for the package associated with the package identifier to the user.

4. The computerized method of claim 1, wherein the entity responsible for the package is a vendor of an item included in the package.

5. The computerized method of claim 1, wherein the entity responsible for the package is a distribution network.

6. The computerized method of claim 1, further comprising:
generating an authentication code that releases the package from the new delivery location when the new delivery location is a secure delivery location;
associating the authentication code with the package identifier;
communicating the authentication code to the secure delivery location; and
transmitting the authentication code to the user.

7. The computerized method of claim 6, wherein communicating the authentication code to the secure delivery location comprises:
transmitting the authentication code directly to the secure delivery location.

8. The computerized method of claim 6, wherein communicating the authentication code to the secure delivery location comprises:
transmitting the authentication code to the entity responsible for the package for subsequent transmission to the secure delivery location.

9. The computerized method of claim 6, wherein transmitting the authentication code to the user causes the authentication code to be stored in a user device that communicates the authentication code to the secure delivery location to release the package.

10. The computerized method of claim 1, wherein the redirection request is received from a user device.

11. The computerized method of claim 10, further comprising:
associating a device identifier for the user device with the package identifier to relate the user and the package without revealing personal information for the user.

12. The computerized method of claim 11, wherein the user device is selected from the group consisting of a privacy card, a digital wallet, and a privacy card coupled to a digital wallet.

13. The computerized method of claim 11, further comprising:
verifying the device identifier through a transaction privacy clearing house to validate the user.

14. A machine-readable medium having executable instructions to cause a machine to perform a method comprising:
receiving a redirection request for a package from a user after completion of an order for an item to be included in the package, the redirection request specifying a package identifier for the package and a new delivery location; and
transmitting the package identifier and the new delivery location to an entity responsible for the package.

15. The machine-readable medium of claim 14, wherein the method further comprises:
sending a delivery notification for the package to the user.

16. The machine-readable medium of claim 14, wherein the method further comprises:
receiving a status request specifying the package identifier from the user; and
transmitting delivery information for the package associated with the package identifier to the user.

17. The machine-readable medium of claim 14, wherein the method further comprises:
generating an authentication code that releases the package from the new delivery location when the new delivery location is a secure delivery location;
associating the authentication code with the package identifier;
communicating the authentication code to the secure delivery location; and
transmitting the authentication code to the user.

18. The machine-readable medium of claim 14, wherein the method further comprises:
associating a device identifier for a user device with the package identifier to relate the user and the package without revealing personal information for the user when the redirection request is received from the user device.

19. The machine-readable medium of claim 18, wherein the method further comprises:
verifying the device identifier through a transaction privacy clearing house to validate the user.

20. A computer system comprising:
a processing unit;
a memory coupled to the processing unit through a bus; and
a package delivery monitoring and management process executed from the memory by the processing unit to cause the processing unit to receive a redirection request for a package from a user after completion of an order for an item to be included in the package and to transmit a package identifier and a new delivery location specified in the redirection request to an entity responsible for the package.

21. The computer system of claim 20, wherein the process further causes the processing unit to send a delivery notification for the package to the user.

22. The computer system of claim 20, wherein the process further causes the processing unit to receive a status request specifying the package identifier from the user and to transmit delivery information for the package associated with the package identifier to the user.

23. The computer system of claim 20, wherein the process further causes the processing unit to generate an authentication code that releases the package from the new delivery location when the new delivery location is a secure delivery location, to associate the authentication code with the package identifier, to communicate the authentication code to the secure delivery location and to transmit the authentication code to the user.

24. The computer system of claim 20, wherein the process further causes the processing unit to associate a device identifier for a user device with the package identifier to relate the user and the package without revealing personal information for the user when the redirection request is received from the user device.

25. The computer system of claim 24, wherein the process causes the processing unit to verify the device identifier through a transaction privacy clearing house to validate the user.

26. A package delivery monitoring and management system comprising:
communication means to communicate between a plurality of users, vendors, and distribution networks;
functional means coupled to the communication means to provide delivery information for a package to a user, to associate a new delivery location with a package in response to a request from a user, and to associate an authentication code with a package that releases the package from a secure delivery location; and
storage means coupled to the function~al means to provide delivery information for packages.
